(19) United States
(12) Patent Application Publication
(10) Pub. No.: US 2025/0018483 A1
(43) Pub. Date: Jan. 16, 2025

(54) BI-DIRECTIONAL BAND SAW AND DUAL-BLADE TENSIONER ASSEMBLY

(71) Applicant: Continental Machines, Inc., Savage, MN (US)

(72) Inventors: Kurt Thomas Plechaty, Jordan, MN (US); Samuel Edwin Weiers, Le Center, MN (US)

(21) Appl. No.: 18/771,274

(22) Filed: Jul. 12, 2024

Related U.S. Application Data
(60) Provisional application No. 63/526,232, filed on Jul. 12, 2023.

(51) Int. Cl. B23D 55/10

(52) U.S. Cl. CPC B23D 55/10

(57) ABSTRACT

A band saw assembly and a blade tensioner assembly are set forth. Unlike many past devices, the band saw assembly has two blades for cutting workpieces—a first blade and a second blade—enabling bi-directional cutting actions in both forward and retract motions. The blade tensioner assembly can be employed to bring both blades of the band saw assembly to equal and proper tensioning values for use, and has a pair of actuators. Potential applications of use include metalworking, woodworking, glass and ceramic material cutting, plastics and fibrous material cutting, and food processing, among many other workpiece possibilities. The band saw assembly may prove particularly useful for high production and manufacturing plants and facilities.

### CROSS-REFERENCE TO RELATED APPLICATION

This application claims the benefit of U.S. Provisional Patent Application No. 63/526,232, with a filing date of Jul. 12, 2023, the contents of which are hereby incorporated by reference in their entirety.

### TECHNICAL FIELD

The present disclosure relates generally to band saws and, more particularly, to band saws with bi-directional cutting actions and blade tensioner assemblies employed in band saws.

### BACKGROUND

Band saws are used for cutting workpieces. They can be found in machine shops, mold shops, manufacturing and production facilities, maintenance departments, and schools, as well as many other places. Applications include metalworking, woodworking, glass and ceramic material cutting, plastics and fibrous material cutting, and food processing, among many other workpiece possibilities. Band saws are typically equipped with a single blade that furnishes unidirectional cutting action amid operation. Maintaining proper tension in the blade is important for overall effectiveness.

### SUMMARY

According to an implementation, a band saw assembly may include a drive wheel, a first wheel, a second wheel, a first blade, a second blade, and a blade tensioner assembly. The first blade is driven by the drive wheel and is carried by the first wheel. Likewise, the second blade is driven by the drive wheel and is carried by the second wheel. The blade tensioner assembly may include a shaft, a first actuator, and a second actuator. The shaft has a first section and has a second section. The second section possesses eccentricity with respect to the first section. The first wheel is situated at the first section, and the second wheel is situated at the second section. The first actuator has a first movement transmission connection with the shaft, and the second actuator has a second movement transmission connection with the shaft. Amid use of the band saw assembly, actuation of the first actuator effects and imparts linear movement to the shaft and to the first and second wheels. At least the first blade is furnished with tension by way of this linear movement; in another implementation, both of the first and second blades are furnished with tension by way of this linear movement. Furthermore, actuation of the second actuator effects and imparts rotational movement to the shaft. Tension is furnished to the second blade by way of the eccentricity of the shaft's second section relative to its first section.

According to another implementation, a band saw assembly may include a first wheel, a second wheel, a first blade, a second blade, and a blade tensioner assembly. The first blade is carried by the first wheel, and likewise the second blade is carried by the second wheel. The blade tensioner assembly may include a shaft, one or more motor actuators, a sliding structural wall, and a sprocket. The shaft has a first section and has a second section. The second section possesses eccentricity with respect to the first section. The first wheel is situated at the first section, and the second wheel is situated at the second section. Upon actuation, the motor actuator(s) effects and imparts movement to the shaft by way of the sliding structural wall, by way of the sprocket, or by way of both the sliding structural wall and the sprocket. Tension is thereby furnished to the first blade, to the second blade, or to both the first and second blades.

According to yet another implementation, a method of establishing approximate equivalence between tension values of a first blade and a second blade of a band saw assembly may include several steps. One step may involve moving a shaft that carries the first and second blades linearly. The linear movement of the shaft bringing the first blade to a first tension value. Another step may involve rotating the shaft rotationally in order to bring the second blade to a second tension value. The first tension value remains unaltered during rotation of the shaft. The first tension value and the second tension value are approximately equal to each other.

Further scope of applicability of the present disclosure will become apparent from the detailed description given hereinafter. But it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

One or more aspects of the disclosure will hereinafter be described in conjunction with the appended drawings, wherein like designations denote like elements, and wherein:

FIG. 1 is a perspective view of a first embodiment of a band saw assembly;

FIG. 2 is an enlarged front view of an embodiment of a blade tensioner assembly that can be equipped in the first embodiment of the band saw assembly;

FIG. 3 is an enlarged view of an embodiment of crown portions of a drive wheel;

FIG. 4 is a perspective view of the blade tensioner assembly;

FIG. 5 is a sectional view of the blade tensioner assembly;

FIG. 6 is a side view of a shaft of the blade tensioner assembly;

FIG. 7 is an end view of the shaft take at arrowed line 7-7 in FIG. 6;

FIG. 8 is a perspective view of an embodiment of an insert;

FIG. 9 is a perspective view of a second embodiment of the band saw assembly;

FIG. 10 is another perspective view of the second embodiment of the band saw assembly;

FIG. 11 is a perspective view of an embodiment of a blade tensioner assembly that can be equipped in the second embodiment of the band saw assembly;

FIG. 12 is a top view of the blade tensioner assembly of FIG. 11;

FIG. 13 is a front view of the blade tensioner assembly of FIG. 11;

FIG. 14 is a rear view of the blade tensioner assembly of FIG. 11;

FIG. 15 is a side view of a shaft of the blade tensioner assembly of FIG. 11;

FIG. 16 is an end view of the shaft taken at arrowed line 16-16 in FIG. 15;

FIG. 17 is an enlarged view of an embodiment of crown portions of a drive wheel; and

FIG. 18 is a front view of another embodiment of a blade tensioner assembly that can be equipped in the band saw assembly.

### DETAILED DESCRIPTION

Referring generally to the drawings, embodiments of a band saw assembly 10 and a blade tensioner assembly 12 are depicted in the figures and described herein. Unlike many past devices, the band saw assembly 10 has two blades for cutting workpieces, enabling bi-directional cutting actions in both forward and retract motions. This advance is effected with a single drive motor and a single blade head equipped in the band saw assembly 10, as presented below, and contrary to previously-known designs and constructions. Bi-directional cutting actions serve to minimize or altogether eliminate parasitic process time losses often involved with single-blade and unidirectional cutting actions, enhancing overall efficiency and effectiveness of band saw operations. Processing time can be reduced by as much as fifty percent (50%) in some cases with use of the band saw assembly 10. Moreover, the blade tensioner assembly 12 can be employed to bring both blades of the band saw assembly 10 to equal and proper tensioning values for use, and even when the blades differ slightly in length relative to each other due to imprecise manufacture and tolerances. Applications of use include metalworking, woodworking, glass and ceramic material cutting, plastics and fibrous material cutting, and food processing, among many other workpiece possibilities. The band saw assembly 10 may prove particularly useful for high production and manufacturing plants and facilities, such as those prevalent in the automotive industry. Still, a particular embodiment of the band saw assembly 10 may exhibit only one, or a combination of, the advancements set forth herein, none of the advancements, or yet other advancements unmentioned.

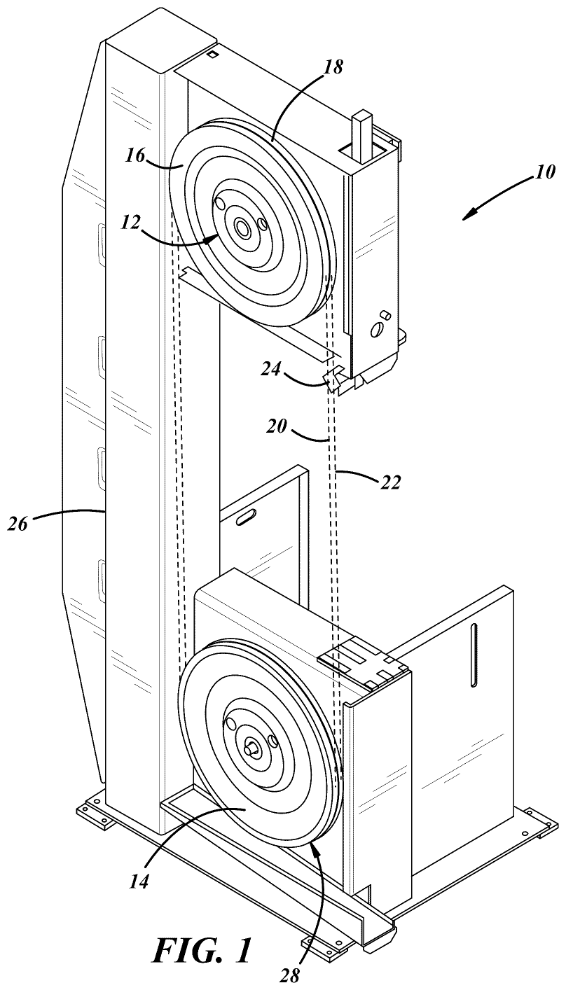

With reference to FIG. 1, a first embodiment of the band saw assembly 10 is presented. The band saw assembly 10 can have varying designs, constructions, and components in various embodiments, depending in part or more upon its intended use and application. In FIG. 1, the band saw assembly 10 exhibits a vertical configuration, but the blade tensioner assembly 12 and the accompanying dual blades could be equipped in a band saw assembly of another configuration such as a horizontal configuration. The band saw assembly 10 includes, as some of its main components: a drive wheel 14, a first and second wheel 16, 18, a first and second blade 20, 22, the blade tensioner assembly 12, and a blade insert 24. Still, other components and assemblies of the band saw assembly 10 could include one or more of the following, depending on the embodiment: a frame 26, lower- and upper-wheel covers, a workpiece table, a guide post, a cooling system, an electronic controller, and a human-machine interface (HMI), among other possibilities. Still further, other variations of the band saw assembly 10 could include more components, less components, and/or different components than those presented here.

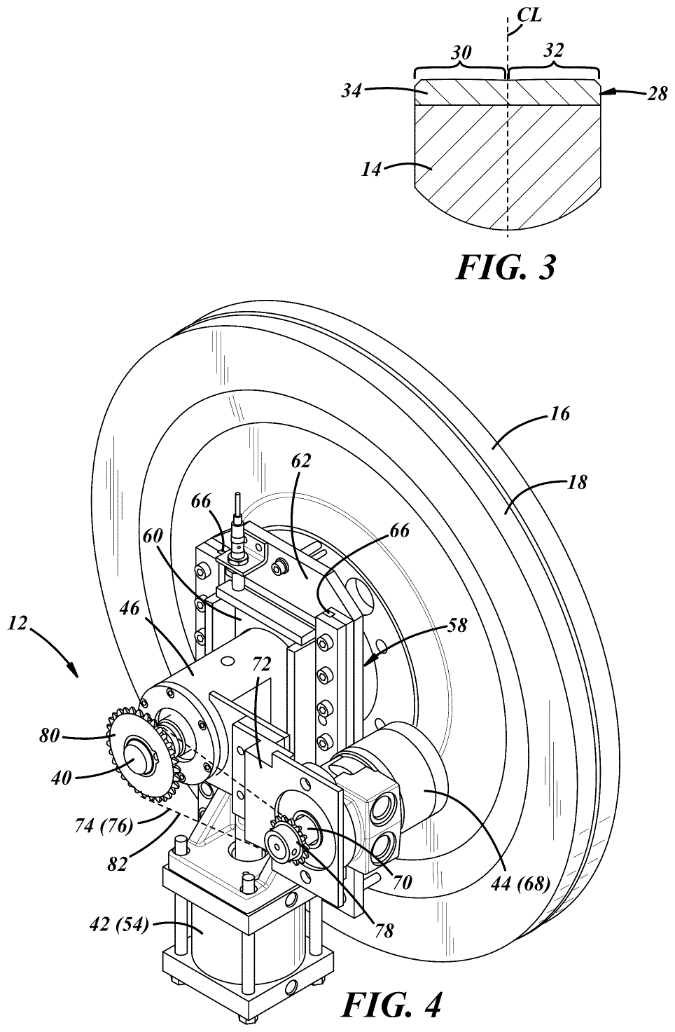

The drive wheel 14 transmits rotational drive input to the first and second blades 20, 22. A drive motor (unshown) imparts rotational drive to the drive wheel 14 and about a drive shaft. The drive wheel 14 carries both of the first and second blades 20, 22 about its circumferential perimeter 28. With particular reference to FIG. 3, the first blade 20 is carried on a first side of the drive wheel 14, and the second blade 22 is carried on a second side of the drive wheel 14. The first and second blades 20, 22 are positioned next to each other and side-by-side at the circumferential perimeter 28. In order to facilitate seating and centering of the first and second blades 20, 22 on the drive wheel 14, the drive wheel 14 in this embodiment has a first crown portion 30 and a second crown portion 32 residing at the circumferential perimeter 28. The first and second crown portions 30, 32 constitute an outermost boundary of the drive wheel 14. The first blade 20 is seated on the first crown portion 30, and the second blade 22 is seated on the second crown portion 32. The first and second crown portions 30, 32 adjoin each other. Each of the first and second crown portions 30, 32 are slightly curved and convex formations in which the first and second blades 20, 22 can be centered roughly at the peak of the respective curvature. Relative to each other, the first and second crown portions 30, 32 are mirror images about a center line CL that is established at the drive wheel's perimeter.

In the embodiment of FIG. 3, the first and second crown portions 30, 32 are formed via a urethane layer 34 disposed at a perimeter of a metal portion of the drive wheel 14. The first and second crown portions 30, 32 can be formed of the same and single urethane layer 34, as depicted. In an example, the urethane layer 34 has a thickness of approximately 0.225 inches, and has an axial length that measures approximately 1.625 inches; still, other dimensions are possible in other examples. Furthermore, in other embodiments the first and second crown portions 30, 32 can take differing forms; for example, the first and second crown portions 30, 32 could be formed via monolithic portions of the drive wheel itself and could hence be made of the same metal material of the drive wheel 14; in yet another example, the first and second crown portions 30, 32 could be formed of a material other than urethane.

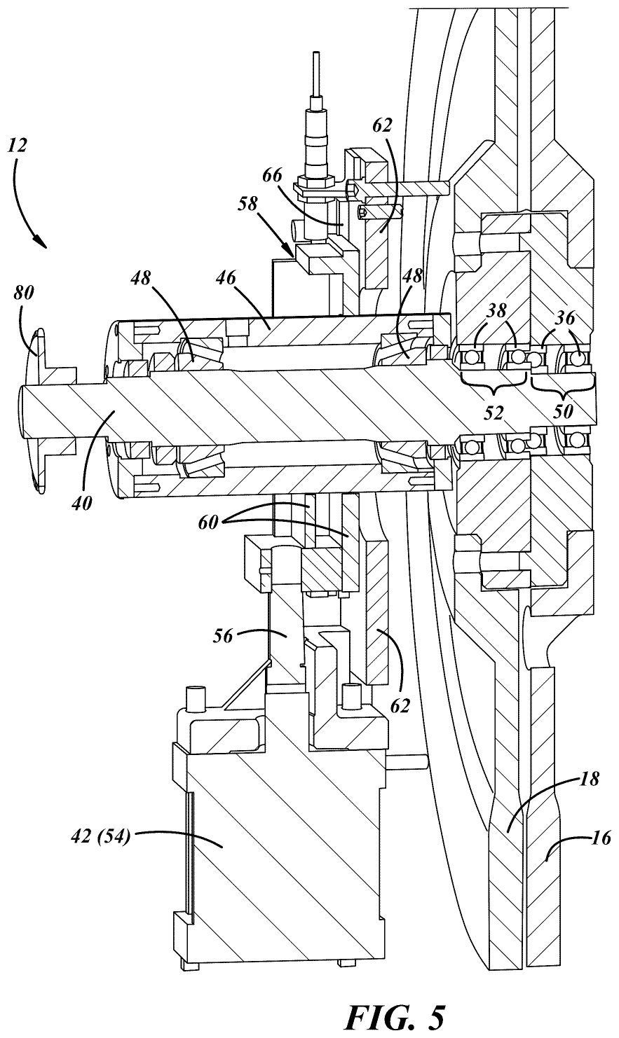

The first and second wheels 16, 18 carry the first and second blades 20, 22 as the blades are driven to revolve via the drive wheel 14. The first and second wheels 16, 18 are driven idler wheels, and rapidly and freely rotate during use of the band saw assembly 10. In assembly, the first and second wheels 16, 18 are situated next to each other and side-by-side, and constitute a two-wheel idler assemblage. With respect to the drive wheel 14, and as illustrated in FIG. 1, the first and second wheels 16, 18 are located at an upper region of the band saw assembly 10, with the drive wheel 14 set at a lower region, per this vertical configuration embodiment. Referring now to FIGS. 4 and 5, the first and second wheels 16, 18 are carried and situated on the same shaft (introduced below) of the blade tensioner assembly 12. The first and second wheels 16, 18 can rotate independently with respect to the shaft. A first pair of bearings 36 is located between the first wheel 16 and the shaft to facilitate rotation of the first wheel 16 thereabout; and likewise, a second pair of bearings 38 is located between the second wheel 18 and the shaft to facilitate rotation of the second wheel 18 thereabout. In order to set and maintain the tension of the first and second blades 20, 22 during use of the band saw assembly 10, the blade tensioner assembly 12 interacts and engages with both of the first and second wheels 16, 18, as described in greater detail below.

The first and second blades 20, 22 revolve rapidly about the drive wheel 14 and about the first and second wheels 16, 18 amid operation and use of the band saw assembly 10. The first and second blades 20, 22 are separate and discrete components with respect to each other, and each have an endless loop configuration. The first blade 20 spans around the drive wheel 14 and the first wheel 16, while the second blade 22 spans around the drive wheel 14 and the second wheel 18. Each of the first and second blades 20, 22 has a band body and a cutting edge. The cutting edge can have a set of protruding cutting teeth, or can have an abrasive material adhered thereto (e.g., diamond or cubic boron nitride (CBN)). When installed at the drive wheel 14 and first and second wheels 16, 18, the cutting edge of the first and second blades 20, 22 are positioned in opposite directions-one for forward cutting actions and the other for rearward cutting actions of the workpiece. In an example, the first and second blades 20, 22 are sized with one inch band bodies; still, other sizes are possible in other examples.

The blade tensioner assembly 12 imparts constant tension to the first and second blades 20, 22 as they are held about the drive wheel 14 and the first and second wheels 16, 18. The tension is initially set and maintained amid use of the band saw assembly 10 via the blade tensioner assembly 12. The tension values for the first blade 20 and for the second blade 22 are set and maintained approximately equivalent and equal to each other via the blade tensioner assembly 12. That is, a first tension value of the first blade 20 is approximately equal to a second tension value of the second blade 22. In an example, the tension values of the first and second blades 20, 22 can range between 28,000 pounds per square inch (PSI) and 32,000 PSI; still, other tension values are possible in other examples. The precise tension values employed could be based on blade configuration and material cutting requirements, among other possible factors. The blade tensioner assembly 12 is installed adjacent the first and second wheels 16, 18 at the upper region of the band saw assembly 10. There, the blade tensioner assembly 12 can be mounted to one or more walls or other structures of the frame 26. Certain components of the blade tensioner assembly 12 can be moved independent of, and with respect to, these frame walls and/or structures amid tension adjustment actions, an embodiment of which is set forth below. The blade tensioner assembly 12 can have varying designs, constructions, and components in various embodiments, depending in part or more upon the desired tension values of the blades, the design and construction of other components of the band saw assembly 10, and the intended use and application of the band saw assembly 10; still, other and/or different factors may play a role.

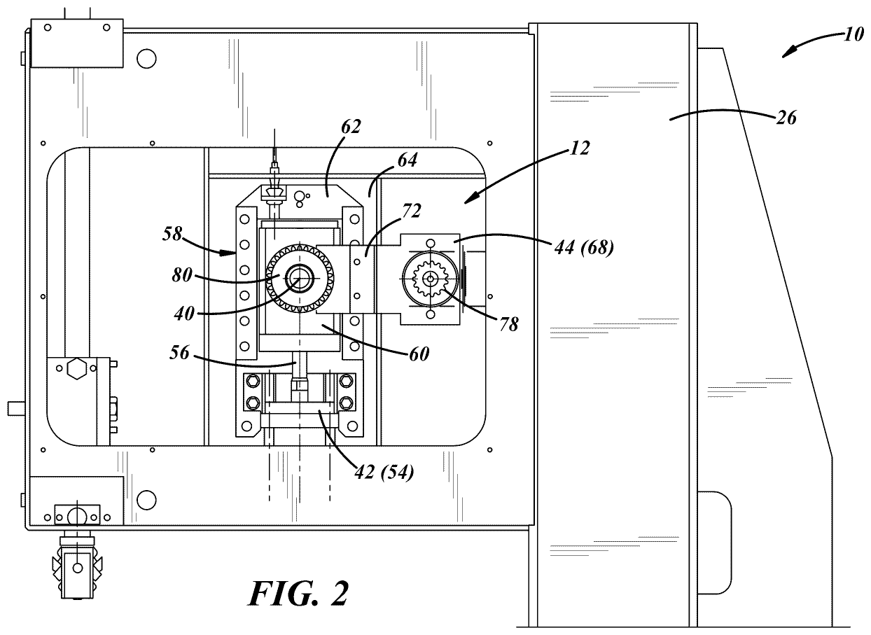

In the first embodiment, and with reference now to FIGS. 2, 4, and 5, the blade tensioner assembly 12 includes a shaft 40, a first actuator 42, and a second actuator 44. The first and second actuators 42, 44 interact and manipulate the shaft 40 in order to adjust (e.g., increase) the tensions of the first and second blades 20, 22 and tighten them around the drive wheel 14 and the first and second wheels 16, 18. Certain adjustments and movements are made to the shaft 40 via the first and second actuators 42, 44 for tensioning and tightening, as described below. The shaft 40 carries the first and second wheels 16, 18 at one end thereof. At an opposite end, the shaft 40 carries a sprocket (subsequently introduced) for manipulation by the second actuator 44. A sleeve housing 46 surrounds an axial portion of the shaft 40 that juts out away from the first and second wheels 16, 18. The sleeve housing 46 serves to facilitate manipulation of the shaft 40 by the first actuator 42. Rotational movement can be imparted to the shaft 40 independent of the sleeve housing 46. Bearings 48 are situated at an interior of the sleeve housing 46 and between the shaft 40 and the sleeve housing 46, as depicted in FIG. 5.

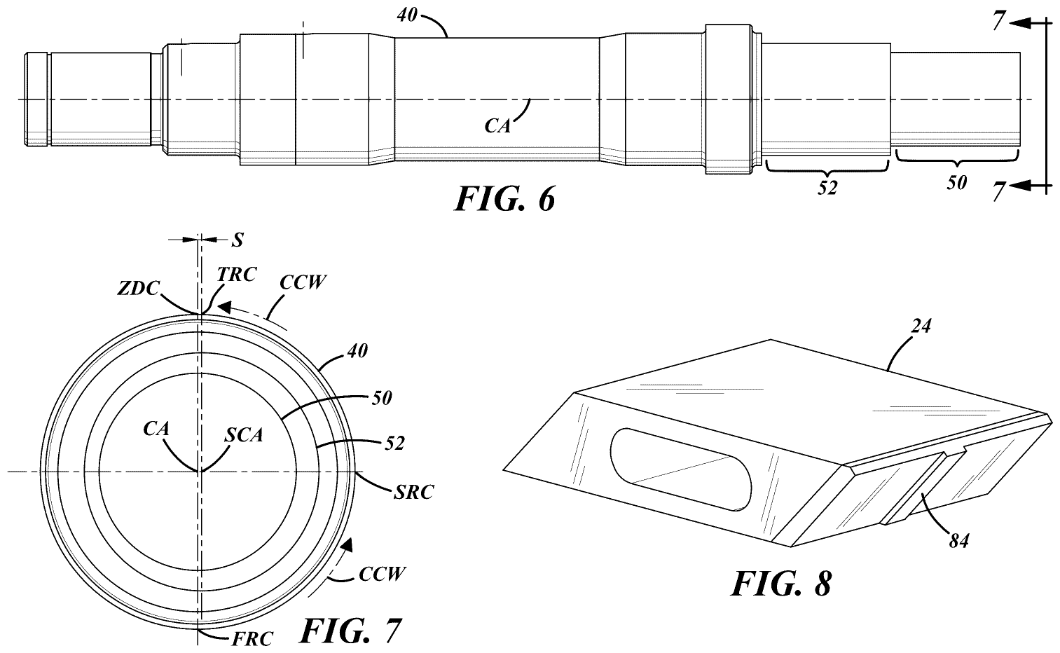

Furthermore, according to this embodiment, in order to furnish equal tension to both of the first and second blades 20, 22, the shaft 40 is designed and constructed with an eccentric section that carries the second wheel 18 and that serves as a cam of sorts for the second wheel 18 and second blade 22 upon rotational movement of the shaft 40. With reference now to FIGS. 6 and 7, the shaft 40 has a first section 50 where the first wheel 16 is situated and carried, and has a second section 52 where the second wheel 18 is situated and carried. The first and second sections 50, 52 adjoin each other and reside next to each other along the axial extent of the shaft 40. The first section 50 is aligned and coincident with a center axis CA of the shaft 40. The second section 52, on the other hand, is offset relative to the shaft's center axis CA and, hence, relative to the first section 50. The second section 52 has a second center axis SCA that is slightly offset and misaligned with the shaft's center axis CA. Because of this offset, eccentricity is established between the second section 52 and the first section 50 and, more broadly, between the second section 52 and the remaining sections of the shaft 40. The second section 52 possesses slight eccentricity with respect to the first section 50. The value of the offset between the center axis CA and the second center axis SCA—and thus the degree of eccentricity between the first and second sections 50, 52—can vary according to different embodiments. In an example, the offset can range between approximately 0.020 inches and 0.025 inches; still, other values are possible in other examples.

The first actuator 42 imparts linear and sliding movement to the shaft 40 and, in turn, to the first and second wheels 16, 18 amid use of the band saw assembly 10. The movement serves to tighten and increase tension of both of the first and second blades 20, 22, and conversely can serve to loosen both of the first and second blades 20, 22, depending on the direction of the movement. With reference to FIGS. 2, 4, and 5, the movement in this embodiment is a vertical upward and downward motion with respect to a ground surface beneath the band saw assembly 10. Upward movement tightens the first and second blades 20, 22, while downward movement loosens the first and second blades 20, 22. In this embodiment, the first actuator 42 is a hydraulic cylinder actuator 54 that exerts a unidirectional force via a unidirectional stroke; still, other types of actuators are possible in other embodiments. Among its components, the hydraulic cylinder actuator 54 has a piston rod 56 that moves back and forth in response to pressurized fluid delivered by a hydraulic pump (unshown). As used herein, the phrase “motor actuator” is intended to encompass devices that provide output force, torque, and/or displacement via an electrical, pneumatic, and/or hydraulic input; examples include hydraulic or pneumatic cylinder actuators, hydraulic motors, and electric motors.

Furthermore, the shaft's linear movement is piloted and guided by a slide assembly 58, per this embodiment. The slide assembly 58 can have varying designs, constructions, and components in various embodiments. Referring to FIGS. 4 and 5, here the slide assembly 58 includes a sliding structural wall 60 and a mounted structural wall 62. The sliding structural wall 60 moves with respect to the mounted structural wall 62 which itself remains static with the frame 26 of the band saw assembly 10. The sliding structural wall 60 is connected with the piston rod 56 or at least engages with it. The sliding structural wall 60 supports and carries the sleeve housing 46. The sleeve housing 46, shaft 40, and first and second wheels 16, 18 move with the sliding structural wall 60 upon actuation of the first actuator 42, and move with respect to the mounted structural wall 62. The mounted structural wall 62 is mounted to a frame wall 64 (FIG. 2) via bolting. The sliding structural wall 60 moves in slots 66 residing at opposite sides of, and established in part by, the mounted structural wall 62. As described, a first movement transmission connection is established between the first actuator 42 and the shaft 40 in order to transmit movement from the first actuator 42 and to the shaft 40. The first movement transmission connection, depending on the particular embodiment, can involve the sliding structural wall 60 and/or the sleeve housing 46; still, other embodiments could include more, less, and/or different components and structures that constitute the first movement transmission connection. In yet other embodiments, the sliding functionality could be carried out with other designs, constructions, and components such as via linear bearing mechanisms.

The second actuator 44 imparts rotational movement to the shaft 40 amid use of the band saw assembly 10. The movement serves to further tighten and increase tension of the second blade 22, should it be determined that such additional tightening and tensioning is desired and necessary in order to bring the second tension value of the second blade 22 in correspondence with the first tension value of the first blade 20. In this regard, a supplemental and secondary tensioning of the second blade 22 is carried out. The tensioning procedure with the blade tensioner assembly 12 and the first and second actuators 42, 44, has been shown to resolve shortcomings ascertained in certain cases with the implementation and use of a pair of distinct blades. When the blades are manufactured, cut to length, and then welded to produce an endless loop, the blades (e.g., first and second blades 20, 22) could differ slightly in overall length and overall extent of the endless loop due to imprecise manufacture and tolerances. Lengths have been observed to vary by as much as 0.05 inches, for example. Refining the first and second tension values of the first and second blades 20, 22 via the second actuator 44 has been found to account for any variation in lengths and, accordingly, to help ensure equivalency therebetween. Proper and equal tension between the first and second blades 20, 22 enhances blade durability and life, and enhances quality and consistency with workpiece cutting actions in both forward and rearward directions.

With reference to FIG. 4, the imparted movement in this embodiment is rotational movement about the center axis CA of the shaft 40. The rotational movement is less than a full three-hundred-and-sixty-degree (360°) revolution of the shaft 40 and—depending on the determined degree of tensioning adjustment necessary to establish equivalence between the first and second tension values of the first and second blades 20, 22—can be greater than 0° of rotational movement and less than 180° of rotational movement, and/or can be less than or equal to 180° of rotational movement, per various embodiments. Upon rotation, for instance, and with reference to FIG. 7, the second section 52 and its eccentric and cammed extent can be rotated counterclockwise CCW and toward a zero-degree coordinate ZDC of the shaft 40. This would serve to further tighten and tension the second blade 22 since the second wheel 18 is situated at the second section 52. An upward peak of the second wheel 18 would be slightly higher than that of the first wheel 16, further tensioning the second blade 22. The second wheel 18 would be raised relative to the first wheel 16 via the eccentric second section 52. The tensioning of the first blade 20, on the other hand, would remain unaffected by the rotational movement of the shaft 40 since the first wheel 16 is situated at the first section 50.

Furthermore, in this embodiment, the second actuator 44 is a hydraulic motor 68 that exerts a torque and angular displacement; still, other types of actuators are possible in other embodiments. Among its components, the hydraulic motor 68 has a motor shaft 70 that rotates in response to pressurized fluid delivered by a hydraulic pump (unshown). The hydraulic motor 68 is supported at its location by a support wall 72 extending from and connected with the sleeve housing 46. A mechanical linkage 74 transmits rotation from the motor shaft 70 and to the shaft 40. The mechanical linkage 74, according to this embodiment, is in the form of a chain drive 76; still, the mechanical linkage could take other forms in other embodiments. The chain drive 76 includes a first sprocket 78, a second sprocket 80, and a roller chain 82. The first sprocket 78 extends from the hydraulic motor 68 and is mounted on the motor shaft 70. In a similar way, the second sprocket 80 extends from the shaft 40 and is mounted on an end thereof. The roller chain 82 spans around the first and second sprockets 78, 80. As described, a second movement transmission connection is established between the second actuator 44 and the shaft 40 in order to transmit movement from the second actuator 44 and to the shaft 40. The second movement transmission connection, depending on the particular embodiment, can involve the mechanical linkage 74 and the chain drive 76; still, other embodiments could include more, less, and/or different components and structures that constitute the second movement transmission connection. Yet additionally, the rotational movement of the shaft 40 could be imparted in other ways and with other designs, constructions, and components according to other embodiments. In an example, the rotational movement could be imparted to the shaft 40 via a linear actuator and a mechanical linkage with link members or lever arms extending between the linear actuator and the shaft 40.

Lastly, and referring now to FIG. 8, the blade insert 24 can be installed adjacent the exit and entry locations of the first and second blades 20, 22 at the upper and lower regions of the band saw assembly 10. The blade insert 24 helps align and guide the first and second blades 20, 22 amid use of the band saw assembly 10. An abutment flange 84 bears forces exerted from the rear of band bodies of the first and second blades 20, 22 amid forward and rearward workpiece cutting actions. The abutment flange 84 has a ridge-like formation in this embodiment, and protrudes from a working surface of the blade insert 24. The first blade 20 is positioned at one side of the abutment flange 84, and the second blade 22 is positioned at the opposite side of the abutment flange 84.

Blade tension settings and adjustments could be automated and commanded by the electronic controller of the band saw assembly 10. The electronic controller could be electrically coupled to the first and second actuators 42, 44, and can control activation and deactivation thereof. Sensors could be equipped at various locations in order to detect the linear and rotational positions of the shaft 40, for example, and could convey those readings to the electronic controller for management of the respective movements of the shaft 40.

A method and procedure of tensioning the first and second blades 20, 22 can involve various steps performed in various sequences. According to an embodiment, in one step the first blade 20 is tightened and tensioned via actuation of the first actuator 42 and via the imparted linear and sliding movement of the shaft 40. This step is meant to bring the first blade 20 to its intended first tension value via the first actuator 42 and via the sliding movement of the shaft 40 and its accompanying components including the sleeve housing 46 and sliding structural wall 60. Since the second blade 22 is also carried on the shaft 40, it too will be tightened as an ancillary effect during this step, but not necessarily tightened to its intended second tension value. Here, the second actuator 44 is in a deactuated and deactivated state. Its motor shaft 70 is able to rotate, as is the shaft 40, when the first actuator 42 imparts linear and sliding movement of the shaft 40 and sleeve housing 46 and sliding structural wall 60. Once the intended first tension value of the first blade 20 is attained, in another subsequent step the second blade 22 is brought to its intended second tension value via the second actuator 44 and via the imparted rotational movement of the shaft 40. While attainment of the intended second tension value is carried out, the previously-attained first tension value of the first blade 20 is unaltered and maintained. Because the shaft 40 and motor shaft 70 are able to rotate amid attainment of the intended first tension value, the tension value of the second blade 22 at this subsequent step will initially be less than the previously-attained first tension value of the first blade 20. This can occur whether the second blade 22 has an overall length and extent that is shorter or longer than that of the first blade 20.

In an example, and with reference to FIG. 7, after attainment of the intended first tension value, the cammed peak of the second section 52 can be located at a first rotational coordinate FRC, which approximates a six o-clock position. If the second blade 22 has an overall length and extent that is shorter than that of the first blade 20, the second actuator 44 is actuated to rotate the shaft 40 counterclockwise (CCW) and toward a second rotational coordinate SRC, which approximates a three o'clock position. Here, the shaft 40 is rotated greater than 0° of rotational movement and less than 90° of rotational movement from the first rotational coordinate FRC. The cammed peak of the second section 52 can hence reside at a rotational and angular position between the six o'clock and three o'clock positions when the intended second tension value for the second blade 22 is attained. Once there, the position of the cammed peak is maintained in order to retain the intended second tension value for the second blade 22. If, on the other hand, the second blade 22 has an overall length and extent that is longer than that of the first blade 20, the second actuator 44 is actuated to rotate the shaft 40 farther counterclockwise (CCW) and toward a third rotational coordinate TRC, which approximates a twelve o'clock position. Here, the shaft 40 is rotated greater than 90° of rotational movement and less than 180° of rotational movement relative to the first rotational coordinate FRC. The cammed peak of the second section 52 can hence reside at a rotational and angular position between the three o'clock and twelve o'clock positions when the intended second tension value for the second blade 22 is attained. Once there, the position of the cammed peak is maintained in order to retain the intended second tension value for the second blade 22. Still, in other examples, other rotational coordinate locations and degrees of rotational movements are possible. In these ways, the intended first and second tension values would be set approximately equivalent and equal to each other via the blade tensioning assembly 12, and could be maintained thereat during subsequent use of the band saw assembly 10.

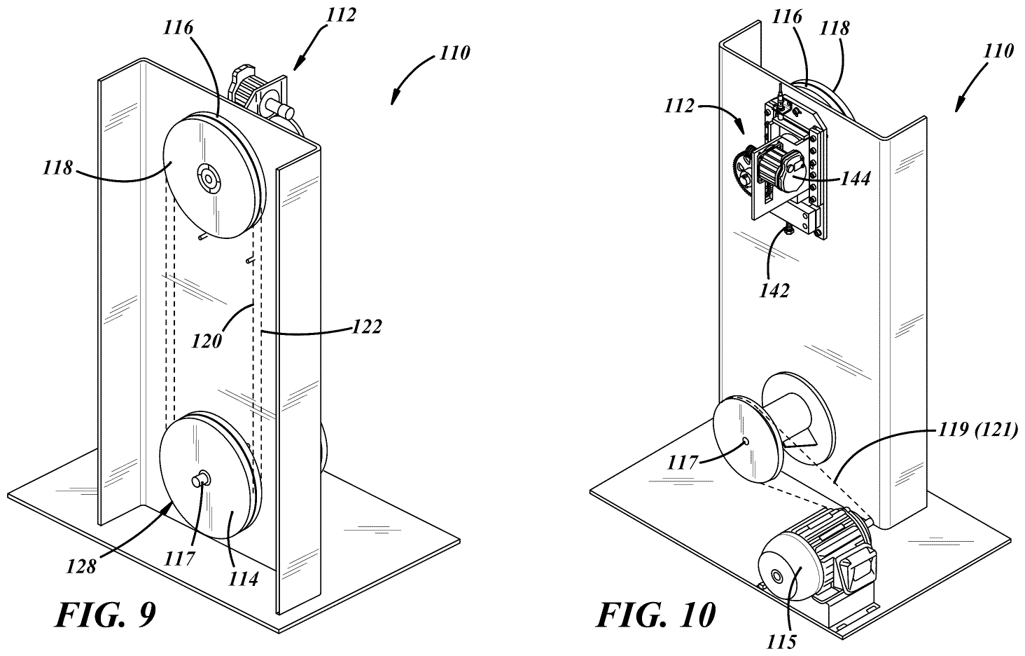

Turning now to FIGS. 9-17, a second embodiment of the band saw assembly is presented. In the second embodiment, corresponding components and elements are numbered similarly but with numerals 1xx when referring to this second embodiment. For example, the band saw assembly is referenced by numeral 10 in the first embodiment, and is correspondingly referenced by numeral 110 in the second embodiment. Moreover, similarities exist between the first embodiment and the second embodiment, some of which may not be repeated here in the description of the second embodiment. At least certain appreciable differences between the embodiments are set forth.

In this second embodiment, the band saw assembly 110 includes, as some of its main components: a drive wheel 114, a drive motor 115, a first and second wheel 116, 118, a first and second blade 120, 122, and a blade tensioner assembly 112. Still, other variations of the band saw assembly 110 could include more components, less components, and/or different components than those presented here.

With general reference to FIGS. 9 and 10, the drive wheel 114 transmits rotational drive input to the first and second blades 120, 122. The drive wheel 114 carries both of the first and second blades 120, 122 about its circumferential perimeter 128. With particular reference to FIG. 17, the first and second blades 120, 122 are positioned next to each other and side-by-side at the circumferential perimeter 128. In order to facilitate seating and centering of the first and second blades 120, 122 on the drive wheel 114, the drive wheel 114 in this embodiment has a first crown portion 130 and a second crown portion 132 (together, called a double crown configuration) residing at the circumferential perimeter 128. The first blade 120 is seated on the first crown portion 130, and the second blade 122 is seated on the second crown portion 132. Further, the drive motor 115 imparts rotational drive to the drive wheel 114 about a drive shaft 117. The drive motor 115 can be an electric motor or another type of motor. A mechanical linkage 119 transmits rotation from the drive motor 115 and to the drive shaft 117. The mechanical linkage 119, according to this embodiment, is in the form of a chain drive 121; still, the mechanical linkage could take other forms in other embodiments.

As before, in this second embodiment the blade tensioner assembly 112 imparts constant tension to the first and second blades 120, 122 as they are held about the drive wheel 114 and the first and second wheels 116, 118. The tension is initially set and maintained amid use of the band saw assembly 110 via the blade tensioner assembly 112. The tension values for the first blade 120 and for the second blade 122 are set and maintained approximately equivalent and equal to each other via the blade tensioner assembly 112. The blade tensioner assembly 112 can have varying designs, constructions, and components in various embodiments, depending in part or more upon the desired tension values of the blades, the design and construction of other components of the band saw assembly 110, and the intended use and application of the band saw assembly 110; still, other and/or different factors may play a role.

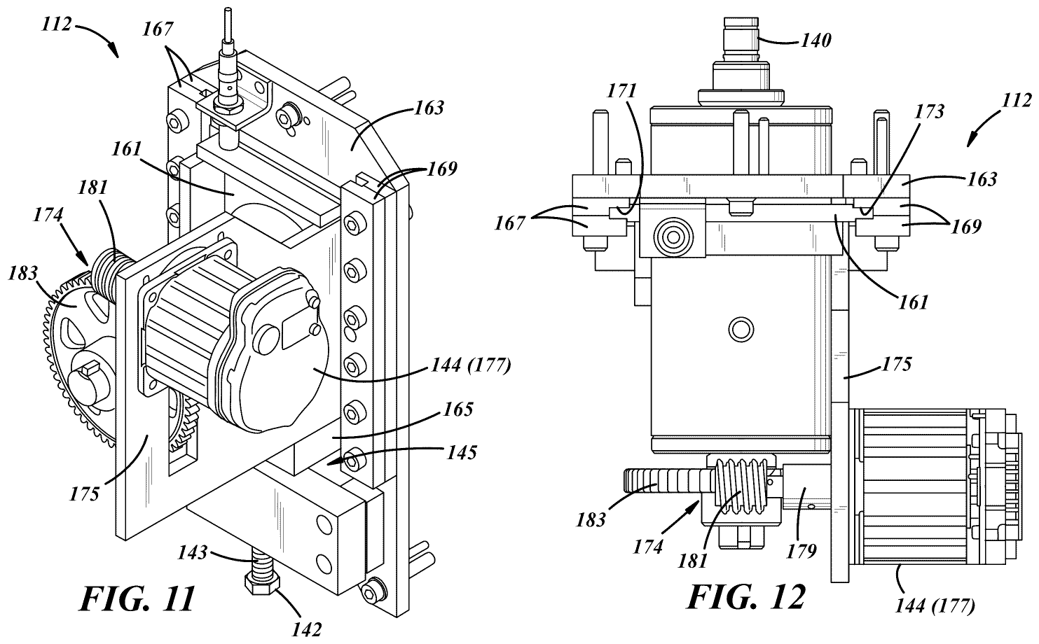

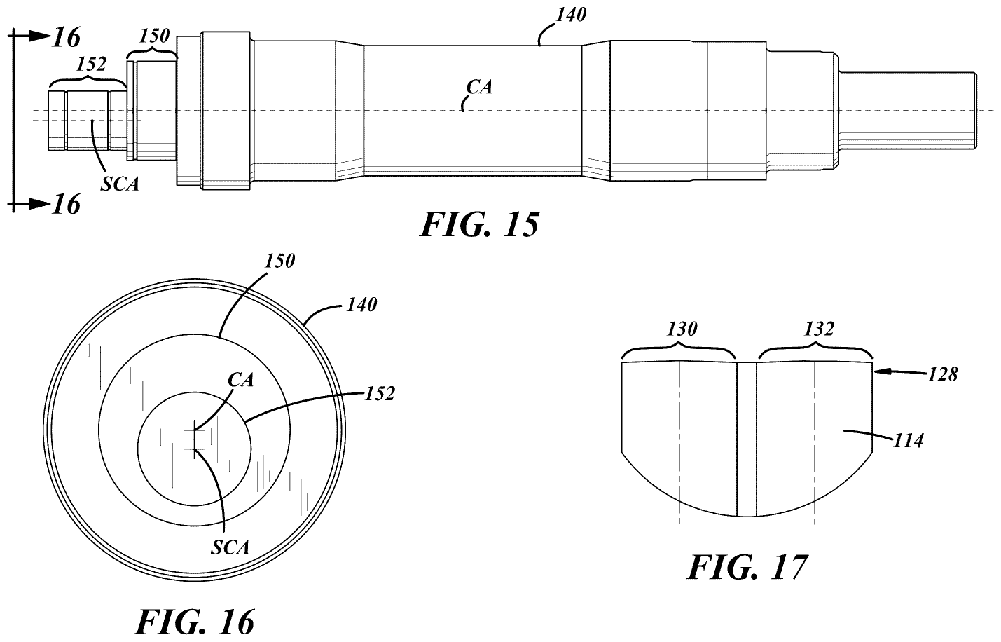

In the second embodiment, and with reference now to FIGS. 11-14, the blade tensioner assembly 112 includes a shaft 140, a first actuator 142, and a second actuator 144. The first and second actuators 142, 144 interact and manipulate the shaft 140 in order to adjust (e.g., increase) the tensions of the first and second blades 120, 122 and tighten them around the drive wheel 114 and the first and second wheels 116, 118. Certain adjustments and movements are made to the shaft 140 via the first and second actuators 142, 144 for tensioning and tightening. The shaft 140 carries the first and second wheels 116, 118 at one end thereof. At an opposite end, the shaft 140 carries a sprocket (introduced below) for manipulation by the second actuator 144. Further, in order to furnish equal tension to both of the first and second blades 120, 122, the shaft 140 is designed and constructed with an eccentric section that carries the second wheel 118 and that serves as a cam of sorts for the second wheel 118 and second blade 122 upon rotational movement of the shaft 140. With reference now to FIGS. 15 and 16, the shaft 140 has a first section 150 where the first wheel 116 is situated and carried, and has a second section 152 where the second wheel 118 is situated and carried. The first and second sections 150, 152 adjoin each other and reside next to each other along the axial extent of the shaft 140. The first section 150 is aligned and coincident with a center axis CA of the shaft 140. The second section 152, on the other hand, is offset relative to the shaft's center axis CA and, hence, relative to the first section 150. The second section 152 has a second center axis SCA that is slightly offset and misaligned with the shaft's center axis CA. Because of this offset, eccentricity is established between the second section 152 and the first section 150 and, more broadly, between the second section 152 and the remaining sections of the shaft 140. The value of the offset between the center axis CA and the second center axis SCA—and thus the degree of eccentricity between the first and second sections 150, 152—can vary according to different embodiments. In an example, the offset can range between approximately 0.100 inches and 0.150 inches or can be approximately 0.125 inches; still, other values are possible in other examples.

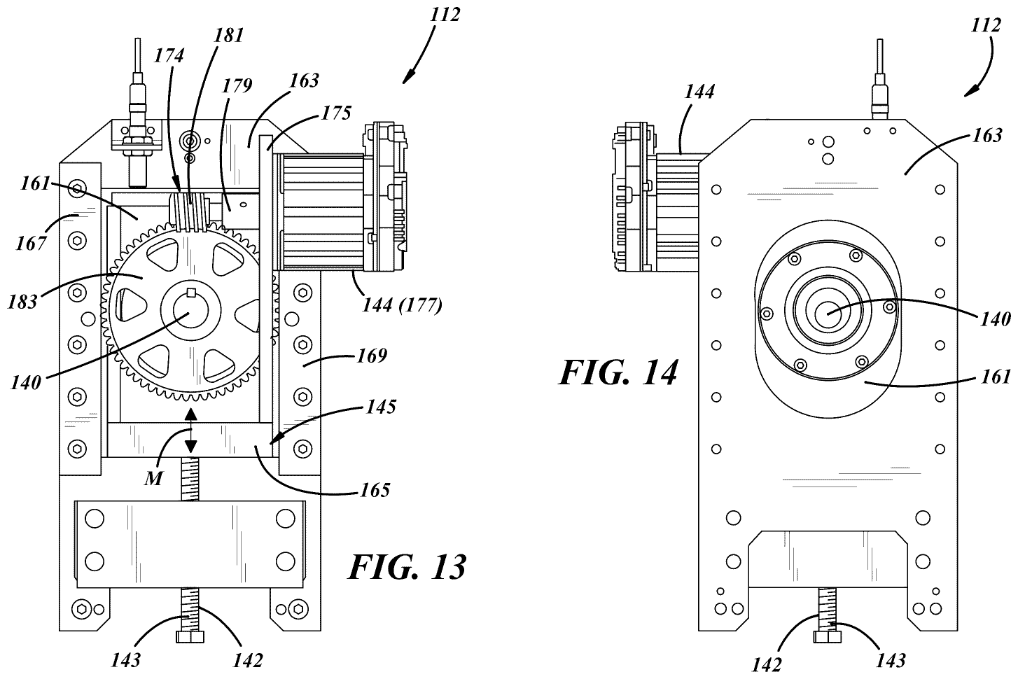

Returning to FIGS. 11-14, the first actuator 142 imparts linear and sliding movement to the shaft 140 and, in turn, to the first and second wheels 116, 118 amid use of the band saw assembly 110. The movement serves to tighten and increase tension of both of the first and second blades 120, 122, and conversely can serve to loosen both of the first and second blades 120, 122, depending on the direction of the movement. In particular, the first actuator 142 is used to bring the first blade 120 to its intended first tension value. In the second embodiment, the first actuator 142 is in the form of a tensioning bolt 143 and a slide assembly or sliding mechanism 145. In this regard, “actuator” is intended to encompass motor actuators as well as actuators that lack a motor. The tensioning bolt 143 can be manually actuated and turned and rotated clockwise or counterclockwise in order to impart unidirectional movement of the sliding mechanism 145; still, other types of actuators are possible in other embodiments. The sliding mechanism 145 pilots and guides vertically upward and downward movement of the shaft 140 and first and second wheels 116, 118 about arrowed line M (vertical is used with reference to the orientation presented in FIG. 13). The sliding mechanism 145 can have varying designs, constructions, and components in various embodiments. In this embodiment, the sliding mechanism 145 includes a sliding structural wall 161 and a mounted structural wall 163. The sliding structural wall 161 moves with respect to the mounted structural wall 163 which itself remains static with the frame of the band saw assembly 110. The sliding structural wall 161 is connected with a tensioning block 165 or at least engages with it. The tensioning block 165 is engaged by the tensioning bolt 143 and moves vertically upward and downward as the tensioning bolt 143 is rotated clockwise or counterclockwise. Guide rails 167, 169 support movement of the sliding structural wall 161 via slots 171, 173 residing therebetween and a slotted engagement exhibited therebetween. The sliding structural wall 161 supports and carries the shaft 140. A further structural wall 175 extends from the sliding structural wall 161 and moves with it amid vertically upward and downward movement. The second actuator 144 is mounted to the structural wall 175 and moves with it.

As described, a first movement transmission connection is established between the first actuator 142 and the shaft 140 in order to transmit movement from the first actuator 142 and to the shaft 140. The first movement transmission connection, depending on the particular embodiment, can involve the sliding structural wall 161 and/or the tensioning block 165; still, other embodiments could include more, less, and/or different components and structures that constitute the first movement transmission connection. In yet other embodiments, the sliding functionality could be carried out with other designs, constructions, and components.

The second actuator 144 imparts rotational movement to the shaft 140 amid use of the band saw assembly 110. The movement serves to further tighten and increase tension of the second blade 122, should it be determined that such additional tightening and tensioning is desired and necessary in order to bring the second tension value of the second blade 122 in correspondence with the first tension value of the first blade 120, as previously described in connection with the first embodiment. In the embodiment, the second actuator 144 is an electric motor 177 that exerts a torque and angular displacement; still, other types of actuators are possible in other embodiments. Among its components, the electric motor 177 has a motor shaft 179 that rotates in operation. The electric motor 177 is supported at its location by structural wall 175. Further, a mechanical linkage 174 transmits rotation from the electric motor 177 and motor shaft 179 and to the shaft 140. The mechanical linkage 174, according to this embodiment, is in the form of a worm gear 181 and a sprocket 183; still, the mechanical linkage could take other forms in other embodiments. The worm gear 181 extends from and is mounted to the motor shaft 179 and rotates therewith. The sprocket 183 extends from the shaft 140 and is mounted on an end thereof. The worm gear 181 engages the sprocket 183 amid assembly and use, and imparts rotational motion to the sprocket 183 and hence to the shaft 140.

As described, a second movement transmission connection is established between the second actuator 144 and the shaft 140 in order to transmit movement from the second actuator 144 and to the shaft 140. The second movement transmission connection, depending on the particular embodiment, can involve the mechanical linkage 174, the worm gear 181, and/or the sprocket 183; still, other embodiments could include more, less, and/or different components and structures that constitute the second movement transmission connection. Yet additionally, the rotational movement of the shaft 140 could be imparted in other ways and with other designs, constructions, and components according to other embodiments.

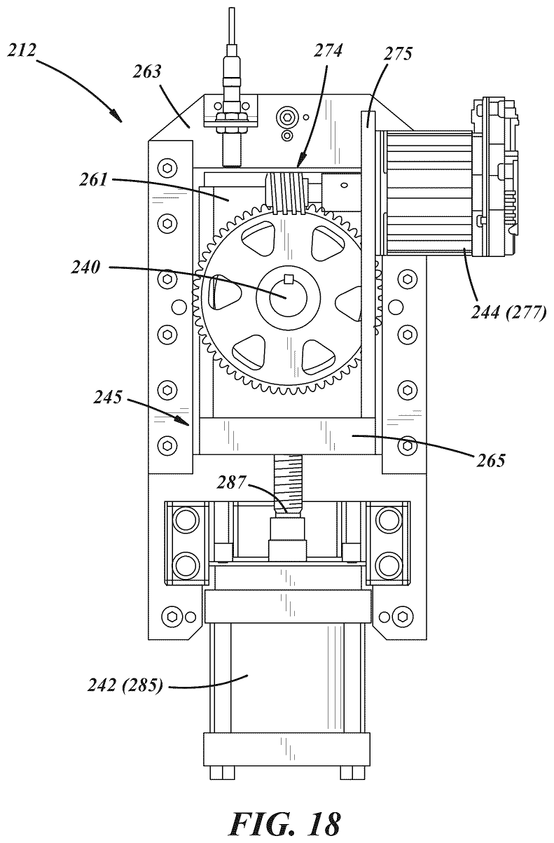

Turning now to FIG. 18, a third embodiment of the band saw assembly is presented. In the third embodiment, corresponding components and elements are numbered similarly but with numerals 2xx when referring to this third embodiment. Similarities exist between the first and second embodiment and the third embodiment, some of which may not be repeated here in the description of the third embodiment. At least certain appreciable differences between the embodiments are set forth.

A blade tensioner assembly 212 of the third embodiment shares many similarities with the blade tensioner assembly 112 of the second embodiment. One main difference is a first actuator 242. As before, the first actuator 242 imparts linear and sliding movement to a shaft 240 and, in turn, to the first and second wheels amid use of the band saw assembly. The movement serves to tighten and increase tension of both of the first and second blades, and conversely can serve to loosen both of the first and second blades, depending on the direction of the movement. In the third embodiment, the first actuator 242 is in the form of a hydraulic cylinder actuator 285 that exerts a unidirectional force via a unidirectional stroke; still, other types of motor actuators are possible in other embodiments. Among its components, the hydraulic cylinder actuator 285 has a piston rod 287 that moves back and forth in response to pressurized fluid. A sliding mechanism 245 pilots and guides vertically upward and downward movement of the shaft 240. The sliding mechanism 245 can have varying designs, constructions, and components in various embodiments. In this embodiment, the sliding mechanism 245 includes a sliding structural wall 261 and a mounted structural wall 263. The sliding structural wall 261 is connected with a tensioning block 265 or at least engages with it. The tensioning block 265 is engaged by the piston rod 287 and moves vertically upward and downward in response thereto.

Furthermore, in general, while a multitude of embodiments have been depicted and described with a multitude of components in each embodiment, in alternative embodiments of the band saw assembly the components of various embodiments—e.g., those of the first and second and third embodiments—could be intermixed, combined, and/or exchanged for one another. In other words, components described in connection with a particular embodiment are not necessarily exclusive to that particular embodiment. As an example, the various actuators described could be intermixed, combined, and/or exchanged for one another in variations to the first and second and third embodiments.

As used herein, the terms “general” and “generally” and “substantially” and “approximately” are intended to account for the inherent degree of variance and imprecision that is often attributed to, and often accompanies, any design and manufacturing process, including engineering tolerances—and without deviation from the relevant functionality and intended outcome—such that mathematical precision and exactitude is not implied and, in some instances, is not possible. In other instances, the terms “general” and “generally” and “substantially” and “approximately” are intended to represent the inherent degree of uncertainty that is often attributed to any quantitative comparison, value, and measurement calculation, or other representation.

It is to be understood that the foregoing is a description of one or more aspects of the disclosure. The disclosure is not limited to the particular embodiment(s) disclosed herein, but rather is defined solely by the claims below. Furthermore, the statements contained in the foregoing description relate to particular embodiments and are not to be construed as limitations on the scope of the disclosure or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

What is claimed is:

1. A band saw assembly, comprising:
a drive wheel, a first wheel, and a second wheel;
a first blade driven by said drive wheel and carried by said first wheel, and a second blade driven by said drive wheel and carried by said second wheel; and
a blade tensioner assembly comprising a shaft, a first actuator, and a second actuator, said shaft having a first section and a second section, said second section possessing eccentricity with respect to said first section, said first wheel situated at said first section and said second wheel situated at said second section, said first actuator having a first movement transmission connection with said shaft, said second actuator having a second movement transmission connection with said shaft, actuation of said first actuator imparting linear movement to said shaft and to said first and second wheels and furnishing tension to at least said first blade, and actuation of said second actuator imparting rotational movement to said shaft and furnishing tension to said second blade via the eccentricity of said second section with respect to said first section.

2. The band saw assembly as set forth in claim 1, wherein a first tension value of said first blade and a second tension value of said second blade are approximately equal to each other via said blade tensioner assembly and actuation of said first and second actuators.

3. The band saw assembly as set forth in claim 1, wherein said first actuator is a hydraulic cylinder actuator and said first movement transmission connection comprises structural wall.

4. The band saw assembly as set forth in claim 1, wherein said blade tensioner assembly comprises a sleeve housing surrounding a portion of said shaft, said first movement transmission connection constituted at least in part via said sleeve housing.

5. The band saw assembly as set forth in claim 1, wherein said second actuator is a hydraulic motor and said second movement transmission connection comprises a mechanical linkage.

6. The band saw assembly as set forth in claim 5, wherein said mechanical linkage is a chain drive.

7. The band saw assembly as set forth in claim 6, wherein said chain drive comprises a first sprocket extending from said hydraulic motor, a second sprocket extending from the shaft, and a roller chain spanning around said first and second sprockets.

8. The band saw assembly as set forth in claim 1, wherein said drive wheel has a first crown portion residing at a perimeter thereof and has a second crown portion residing at the perimeter and adjoining said first crown portion, said first crown portion seating said first blade at said drive wheel and said second crown portion seating said second blade at said drive wheel.

9. The band saw assembly as set forth in claim 1, wherein imparting rotational movement to said shaft via actuation of said second actuator involves an imparted rotational movement that is less than or equal to one-hundred-and-eighty degrees (180°) of rotational movement.

10. The band saw assembly as set forth in claim 1, wherein said first actuator comprises a tensioning bolt and said first movement transmission connection comprises a tensioning block.

11. The band saw assembly as set forth in claim 1, wherein said first actuator is a hydraulic cylinder actuator and said first movement transmission connection comprises a tensioning block and a sliding structural wall.

12. The band saw assembly as set forth in claim 1, wherein said second actuator is an electric motor and said second movement transmission connection comprises a mechanical linkage.

13. The band saw assembly as set forth in claim 12, wherein said mechanical linkage comprises a worm gear and a sprocket.

14. The band saw assembly as set forth in claim 1, wherein said first movement transmission connection comprises a sliding structural wall and said second movement transmission connection comprises a sprocket.

15. A band saw assembly, comprising:
a first wheel and a second wheel;
a first blade carried by said first wheel, and a second blade carried by said second wheel; and
a blade tensioner assembly comprising a shaft, at least one motor actuator, a sliding structural wall, and a sprocket, said shaft having a first section and a second section, said second section possessing eccentricity with respect to said first section, said first wheel situated at said first section and said second wheel situated at said second section, upon actuation said at least one motor actuator imparting movement to said shaft via at least one of said sliding structural wall or said sprocket in order to furnish tension to said first blade, to said second blade, or to both said first blade and said second blade.

16. The band saw assembly as set forth in claim 15, wherein a first tension value of said first blade and a second tension value of said second blade are approximately equal to each other via said blade tensioner assembly and actuation of said at least one motor actuator.

17. The band saw assembly as set forth in claim 15, wherein said at least one motor actuator includes a first motor actuator and a second motor actuator, said first motor actuator imparting linear movement to said shaft via said sliding structural wall, said second motor actuator imparting rotational movement to said shaft via said sprocket.

18. The band saw assembly as set forth in claim 15, wherein said at least one motor actuator imparts rotation movement to said shaft via said sprocket in order to furnish tension to said second blade via the eccentricity of said second section with respect to said first section.

19. A method of establishing approximate equivalence between tension values of first and second blades of a band saw assembly, the method comprising:
moving a shaft carrying said first and second blades linearly in order to bring said first blade to a first tension value; and
rotating said shaft rotationally in order to bring said second blade to a second tension value, wherein said first tension value remains unaltered amid rotation of said shaft, and wherein said first tension value and said second tension value are approximately equal to each other.
